(19) United States
(12) Patent Application Publication
(10) Pub. No.: US 2026/0292796 A1
(43) Pub. Date: Sep. 24, 2026

(54) METHOD AND DEVICE FOR PREEMPTION OPERATION IN WIRELESS LAN

(71) Applicant: ELECTRONICS AND TELECOMMUNICATIONS RESEARCH INSTITUTE, Daejeon (KR)

(72) Inventors: Sung Hyun HWANG, Daejeon (KR); Kyu Min KANG, Daejeon (KR); Yong Ho KIM, Incheon (KR); Ju Seong MOON, Osan-si, Gyeonggi-do (KR)

(21) Appl. No.: 19/476,118

(22) PCT Filed: May 10, 2024
(86) PCT No.: PCT/KR2024/006352

§ 371 Date: Oct. 16, 2025

(30) Foreign Application Priority Data
May 12, 2023 (KR) 10-2023-0061891
Aug. 17, 2023 (KR) 10-2023-0107500

(51) Int. Cl. H04W 72/0446; H04L 1/1607; H04W 74/0816

(52) U.S. Cl. CPC H04W 72/0446; H04L 1/1635; H04W 74/0816

(57) ABSTRACT

A method and device for a preemption operation in a wireless LAN are disclosed. The method of an AP comprises the steps of: transmitting, to a first STA, a first frame including first data and preemption information for a preemption operation; conducting transmission/reception of an LL frame with a second STA on the basis of the preemption information; and receiving, from the first STA, a first response frame for the first frame.

### TECHNICAL FIELD

The present disclosure relates to a wireless local area network (LAN) communication technique, and more particularly, to a preemption technique for transmitting low latency (LL) traffic.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multi-access point (AP) transmission operations, and/or efficient retransmission operations (e.g., hybrid automatic repeat request (HARQ) operations).

The Ultra High Reliability (UHR) wireless LAN technology, IEEE 802.11bn standard, is currently under development. The IEEE 802.11bn standard can support technologies for improving reliability and/or low-latency technologies. Power-saving techniques may be required for the wireless LAN. The power-saving techniques may be required not only for stations (STAs) but also for access points (APs).

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for low latency (LL) traffic transmission.

### Technical Solution

A method of an access point (AP), according to exemplary embodiments of the present disclosure for achieving the above-described objective, may comprise: transmitting a first frame to a first station (STA), the first frame including first data and preemption information for a preemption operation; performing a transmission and reception operation of a low latency (LL) frame with a second STA based on the preemption information; and receiving a first response frame for the first frame from the first STA.

The preemption information may include at least one of a preemption field, a final frame field, a random back-off (RBO) contention window (CW) field, or a maximum time field, the preemption field may indicate whether the preemption operation is allowed, the final frame field may indicate whether the first frame including the final frame field is a final frame, the RBO CW field may include parameter(s) for collision avoidance in the preemption operation, and the maximum time filed may indicate a maximum time during which transmission according to the preemption operation is possible.

An interval between the first frame and a next frame may be an LL interframe space (IFS) when the preemption operation is allowed, the interval between the first frame and the next frame may be a short interframe space (SIFS) when the preemption operation is not allowed, and the LL IFS may be set independently of the SIFS.

A transmission time or reception time of a second response frame for the LL frame may be determined based on acknowledgement (ACK) policy information included in the LL frame, and the ACK policy information may indicate a block ACK (BA) or block ACK request (BAR).

The performing of the transmission and reception operation of the LL frame may comprise: receiving the LL frame from the second STA; and transmitting a second response frame for the LL frame to the second STA, wherein the LL frame may be received within an LL IFS from a transmission end time of the first frame, and the second response frame may be transmitted before reception of the first response frame.

The method may further comprise: after transmitting the second response frame, transmitting a second frame including second data to the first STA, wherein the first response frame may be a response frame for the first frame and the second frame.

The method may further comprise: after the LL frame is received from the second STA, receiving, from the second STA, a block ACK request (BAR) frame requesting transmission of a second response frame for the LL frame; and transmitting the second response frame for the LL frame to the second STA.

The performing of the transmission and reception operation of the LL frame may comprise: transmitting the LL frame to the second STA; and receiving a second response frame for the LL frame from the second STA, wherein the LL frame may be transmitted within an LL IFS from a transmission end time of the first frame, and the second response frame may be received before reception of the first response frame.

The method may further comprise: after receiving the second response frame, transmitting a second frame including second data to the first STA, wherein the first response frame may be a response frame for the first frame and the second frame.

The method may further comprise: in response to the LL frame being transmitted to the second STA, transmitting, to the second STA, a block ACK request (BAR) frame requesting transmission of a second response frame for the LL frame; and receiving the second response frame for the LL frame from the second STA.

A method of a second station (STA), according to exemplary embodiments of the present disclosure for achieving the above-described objective, may comprise: obtaining preemption information included in a first frame transmitted by an access point (AP) to a first STA; determining that a preemption operation is allowed based on the preemption information; transmitting a low latency (LL) frame to the AP within an LL interframe space (IFS) from a reception end time of the first frame; and receiving a second response frame for the LL frame from the AP.

The preemption information may include at least one of a preemption field, a final frame field, a random back-off (RBO) contention window (CW) field, or a maximum time field, the preemption field may indicate whether the preemption operation is allowed, the final frame field may indicate whether the first frame including the final frame field is a final frame, the RBO CW field may include parameter(s) for collision avoidance in the preemption operation, and the maximum time filed may indicate a maximum time during which transmission according to the preemption operation is possible.

An interval between the first frame and a next frame may be the LL interframe space (IFS) when the preemption operation is allowed, the interval between the first frame and the next frame may be a short interframe space (SIFS) when the preemption operation is not allowed, and the LL IFS may be set independently of the SIFS.

The second response frame may be received after an SIFS from a transmission end time of the LL frame, and a transmission operation of the second response frame at the AP may be performed before a reception operation of the first response frame for the first frame at the AP.

The method may further comprise: after transmitting the LL frame, transmitting, to the AP, a block acknowledgment request (BAR) frame requesting transmission of a second response frame for the LL frame, wherein the second response frame may be received in response to the BAR frame.

A method of a second station (STA), according to exemplary embodiments of the present disclosure for achieving the above-described objective, may comprise: obtaining preemption information included in a first frame transmitted by an access point (AP) to a first STA; determining that a preemption operation is allowed based on the preemption information; receiving a low latency (LL) frame from the AP within an LL interframe space (IFS) from a reception end time of the first frame; and transmitting a second response frame for the LL frame to the AP.

The preemption information may include at least one of a preemption field, a final frame field, a random back-off (RBO) contention window (CW) field, or a maximum time field, the preemption field may indicate whether the preemption operation is allowed, the final frame field may indicate whether the first frame including the final frame field is a final frame, the RBO CW field may include parameter(s) for collision avoidance in the preemption operation, and the maximum time filed may indicate a maximum time during which transmission according to the preemption operation is possible.

An interval between the first frame and a next frame may be an LL interframe space (IFS) when the preemption operation is allowed, the interval between the first frame and the next frame may be a short interframe space (SIFS) when the preemption operation is not allowed, and the LL IFS may be set independently of the SIFS.

The second response frame may be transmitted after an SIFS from a reception end time of the LL frame, and a transmission operation of the second response frame at the second STA may be performed before a reception operation of a first response frame for the first frame at the AP.

The method may further comprise: after receiving the LL frame, receiving, from the AP, a block acknowledgment request (BAR) frame requesting transmission of the second response frame for the LL frame, wherein the second response frame may be transmitted in response to the BAR frame.

### Advantageous Effects

According to the present disclosure, an AP may divide a single data frame into multiple data frames and transmit the multiple data frames. An interframe space for preemption operations may be controlled by the AP. The AP may determine whether to transmit a response frame (e.g., acknowledgment (ACK) frame or block ACK (BA) frame) and may indicate whether to transmit the response frame. When a STA is a recipient of the data frame, and the AP indicates transmission of the response frame, the STA may transmit a response frame for the data frame received from the AP. When the STA is not a recipient of the data frame, and a low latency (LL) frame for priority transmission exists in the STA, the STA may transmit the LL frame to the AP based on priority transmission control (e.g., preemption control). Based on the priority transmission control, the transmission operation of the LL frame (e.g., priority transmission operation) can be performed smoothly.

### DESCRIPTION OF DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating a first exemplary embodiment of a negotiation procedure for a multi-link operation in a wireless LAN system.

FIG. 5 is a block diagram illustrating exemplary embodiments of a structure of a MAC header for a preemption operation in a wireless LAN.

FIGS. 6A and 6B are timing diagrams illustrating exemplary embodiments of a preemption method.

FIGS. 7A and 7B are timing diagrams illustrating exemplary embodiments of a preemption method.

FIG. 8A and FIG. 8B are timing diagrams illustrating exemplary embodiments of a preemption method.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’. The names of frames proposed in the present disclosure may be generalized such as first frame, second frame, third frame, and the like. In the present disclosure, a transmission time may mean a start time of frame transmission and/or an end time of frame transmission, and a reception time (e.g., completion time) may mean a start time of frame reception and/or an end time (e.g., completion time) of frame reception. Time may be interpreted as a time point depending on a context.

FIG. 1 is a conceptual diagram illustrating a first exemplary embodiment of a wireless LAN system.

Referring to FIG. 1, a wireless LAN system may include at least one basic service set (BSS). A BSS may refer to a set of stations (e.g., STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (AP1) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (AP1) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (AP1), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

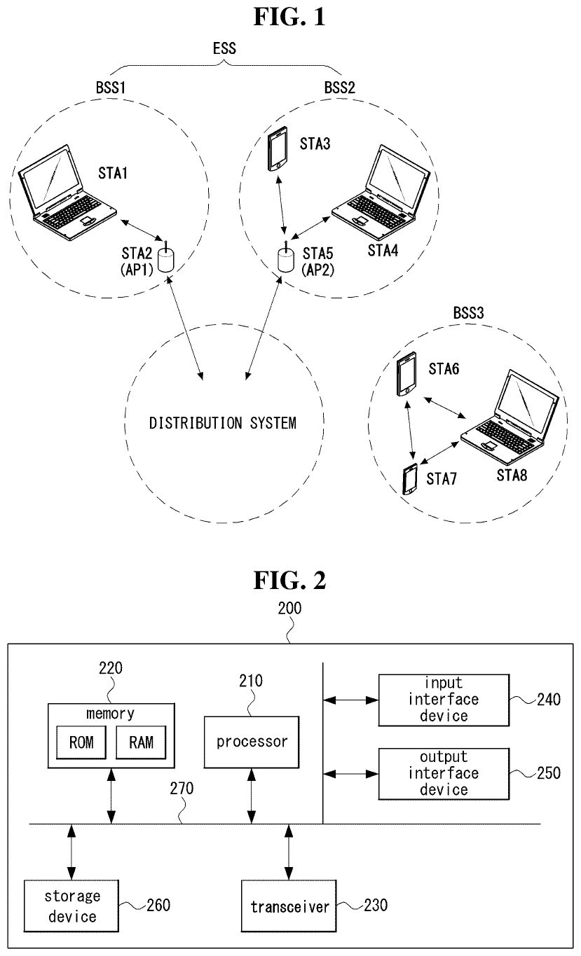

FIG. 2 is a block diagram illustrating a first exemplary embodiment of a communication node constituting a wireless LAN system.

Referring to FIG. 2, a communication node 200 may be an AP, STA, AP MLD, STA MLD, EMLSR AP MLD, or EMLSR STA MLD. The STA may be a non-AP STA. An operating channel width supported by the AP may be 20 megahertz (MHz), 80 MHz, 160 MHz, or the like. An operating channel width supported by the STA may be 20 MHz, 80 MHz, or the like. In the present disclosure, an AP may be interpreted as an AP MLD or EMLSR AP MLD depending on a context, a STA may be interpreted as a STA MLD or EMLSR STA MLD depending on a context, and a MLD may be interpreted as an AP MLD, STA MLD, or EMLSR AP MLD, or EMLSR STA MLD depending on a context. The EMLSR operation may include a MLSR operation. An EMLSR may be interpreted as a MLSR depending on a context, and a MLSR may be interpreted as an EMLSR depending on a context. Operations of an AP MLD may be interpreted as operations of an AP affiliated with the AP MLD, and operations of an AP may be interpreted as operations of an AP MLD affiliated with the AP. Operations of a STA MLD may be interpreted as operations of a STA affiliated with the STA MLD, and operations of a STA may be interpreted as operations of a STA MLD affiliated with the STA.

The communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

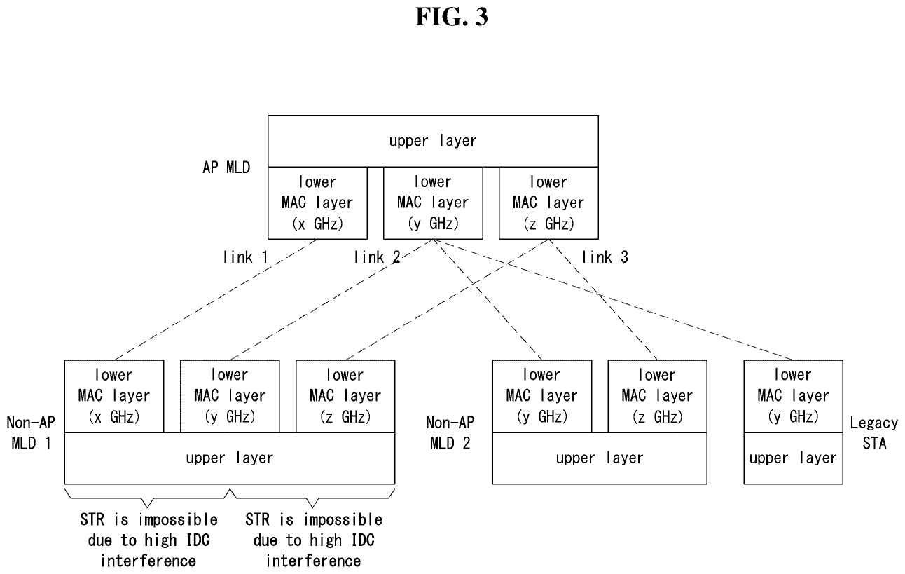

FIG. 3 is a conceptual diagram illustrating a first exemplary embodiment of a multi-link configured between multi-link devices (MLDs).

Referring to FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD). The AP of the AP MLD may mean an AP affiliated with the AP MLD. The STA of the STA MLD may mean a STA affiliated with the STA MLD.

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11 a/b/g/n/ac/ax STA) may be connected to one or more links of the multi-link supported by the AP MLD.

When a band separation between multiple links (e.g., a band separation between a link 1 and a link 2 in the frequency domain) is sufficient, the MLD may be able to perform an STR operation. For example, the MLD may transmit a physical layer convergence procedure (PLCP) protocol data unit (PPDU) 1 using the link 1 among multiple links, and may receive a PPDU 2 using the link 2 among multiple links. On the other hand, if the MLD performs an STR operation when the band separation between multiple links is not sufficient, in-device coexistence (IDC) interference, which is interference between the multiple links, may occur. Accordingly, when the bandwidth separation between multiple links is not sufficient, the MLD may not be able to perform an STR operation.

For example, a multi-link including a link 1, a link 2, and a link 3 may be configured between an AP MLD and a non-AP MLD 1. When a band separation between the link 1 and the link 3 is sufficient, the AP MLD may perform an STR operation using the link 1 and the link 3. That is, the AP MLD may transmit a frame using the link 1 and receive a frame using the link 3. When a band separation between the link 1 and the link 2 is insufficient, the AP MLD may not be able to perform an STR operation using the link 1 and the link 2. When a band separation between the link 2 and the link 3 is not sufficient, the AP MLD may not be able to perform an STR operation using the link 2 and the link 3.

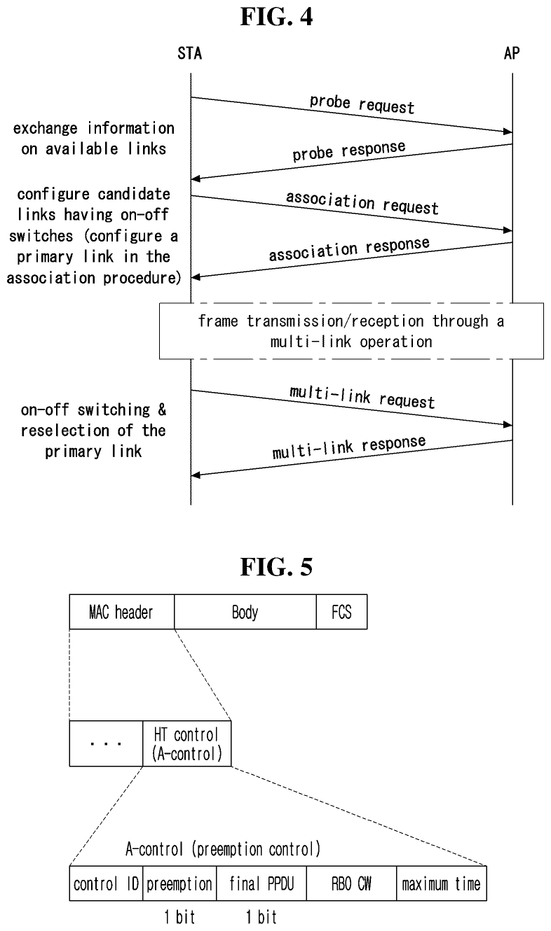

FIG. 4 is a sequence chart illustrating a first exemplary embodiment of a negotiation procedure for a multi-link operation in a wireless LAN system.

Referring to FIG. 4, an access procedure between a STA and an AP in an infrastructure basic service set (BSS) may generally be divided into a probe step of probing AP(s), an authentication step for authentication between the STA and the probed AP, and an association step of association between the STA and the authenticated AP.

In the probe step, the STA may detect one or more APs using a passive scanning scheme or an active scanning scheme. When the passive scanning scheme is used, the STA may detect one or more APs by overhearing beacons transmitted by the one or more APs. When the active scanning scheme is used, the STA may transmit a probe request frame, and may detect one or more APs by receiving probe response frames that are responses to the probe request frame from the one or more APs.

When the one or more APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In particular, the STA may select one AP among AP(s) with which the STA has performed the authentication step, and perform the association step with the selected AP. That is, the STA may transmit an association request frame to the selected AP, and may complete the association with the AP by receiving an association response frame that is a response to the association request frame from the selected AP.

Meanwhile, a multi-link operation may be supported in the wireless LAN system. A multi-link device (MLD) may include one or more STAs affiliated with the MLD. The MLD may be a logical entity. The MLD may be classified into an AP MLD and a non-AP MLD. Each STA affiliated with the AP MLD may be an AP, and each STA affiliated with the non-AP MLD may be a non-AP STA. In order to configure a multi-link, a multi-link discovery procedure, a multi-link setup procedure, and the like may be performed. The multi-link discovery procedure may be performed in the probe step between a STA and an AP. In this case, multi-link information elements (ML IEs) may be included in the beacon frame, the probe request frame, and/or the probe response frame.

For example, in order to perform a multi-link operation, in the probe step, the AP (e.g., AP affiliated with an MLD) may exchange information indicating whether the multi-link operation can be used and information on available link(s) with the STA (e.g., non-AP STA affiliated with an MLD). In a negotiation procedure for the multi-link operation (e.g., multi-link setup procedure), the STA may transmit information of link(s) to be used for the multi-link operation. The negotiation procedure for the multi-link operation may be performed in the access procedure (e.g., association step) between the STA and the AP, and information element(s) required for the multi-link operation may be configured or changed by an action frame in the negotiation procedure.

In addition, in the access procedure (e.g., association step) between the STA and the AP, available link(s) of the AP may be configured, and an identifier (ID) may be assigned to each link. Thereafter, in the negotiation procedure and/or change procedure for the multi-link operation, information indicating whether each link is activated may be transmitted, and the information may be expressed using the link ID(s).

The information indicating whether the multi-link operation can be used may be transmitted and received in a procedure of exchanging capability information element(s) (e.g., EHT capability information element(s)) between the STA and the AP. The capability information element(s) may include information of supporting band(s), information of supporting link(s) (e.g., ID(s) and/or number of supporting link(s)), information of links capable of simultaneous transmission and reception (STR) operations (e.g., information on bands of the links, information on a separation between the links), and/or the like. In addition, the capability information element(s) may include information that individually indicates a link capable of the STR operation.

Exemplary embodiments of the present disclosure may be applied to a single link as well as to multiple links. In other words, exemplary embodiments described as being applied to multiple links may be applied to a single link in the same and/or similar manner. Exemplary embodiments described as being applied to a single link may be applied to multiple links in the same and/or similar manner. A preemption method will be proposed in the present disclosure. The preemption method (e.g., preemption operation) may refer to a priority transmission method (e.g., priority transmission operation). The preemption method may be applied to multiple links and/or a single link. The preemption method may be used for transmission of low latency (LL) traffic. The LL traffic may refer to latency sensitive (LS) traffic. The LL traffic may be referred to as LL data or LL frame. The LS traffic may be referred to as LS data or LS frame. The preemption method may be used for transmission of periodic LL traffic and/or aperiodic LL traffic. Alternatively, the preemption method may be used for transmission of traffic other than LL traffic (e.g., LS traffic).

FIG. 5 is a block diagram illustrating exemplary embodiments of a structure of a MAC header for a preemption operation in a wireless LAN.

Referring to FIG. 5, a frame transmitted by an AP and/or an STA may include a MAC header. The frame may be a physical layer protocol data unit (PPDU), a medium access control layer protocol data unit (MPDU), an aggregated MPDU (A-MPDU), or the like. The frame may be a control frame, a management frame, and/or a data frame. The MAC header may include one or more high throughput (HT) control fields. The HT control field may have an A-control variant form. The HT control field may include control information in an A-control form. Information element(s) for a preemption operation may be included in the HT control field. For example, information element(s) for indicating the preemption operation may be included in the HT control field in an A-control form.

The HT control field may include at least one of a control identifier (ID) field or preemption information (e.g., preemption control information, preemption configuration information). The preemption information may include at least one of a preemption field, a final PPDU field, a random back-off (RBO) contention window (CW) field, or a maximum time field. The control ID field may be a field for distinguishing control information included in the HT control field. The control ID field may indicate preemption control. In other words, the control ID field may indicate that the control information included in the HT control field is preemption control information. When the control ID field indicates preemption control (e.g., preemption operation), the HT control field associated with the control ID field may include information element(s) for the preemption operation.

The preemption field may include information indicating whether a preemption operation (e.g., priority transmission operation) is allowed. For example, the preemption field may include information indicating whether a preemption operation is allowed after a frame transmitted by a communication node (e.g., AP and/or STA). The preemption field may include information indicating whether an uplink (UL) preemption operation is allowed and/or information indicating whether a downlink (DL) preemption operation is allowed. If a UL preemption operation is allowed, the STA may transmit LL traffic to the AP. In other words, the STA may transmit LL traffic to the AP by performing the UL preemption operation. If a DL preemption operation is allowed, the AP may transmit LL traffic to the STA. In other words, the AP may transmit LL traffic to the STA by performing the DL preemption operation.

The preemption field may include information indicating which interframe space (IFS) is used after the frame transmitted by the AP. The size of the preemption field may be 1 bit. A first value (e.g., 0) of the preemption field may indicate that the preemption operation is allowed (e.g., preemption operation is allowed after transmission of the frame of the communication node). A second value (e.g., 1) of the preemption field may indicate that the preemption operation is not allowed (e.g., preemption operation is not allowed after transmission of the frame of the communication node).

If the preemption operation is allowed, an X interframe space (XIFS) may be used instead of a short interframe space (SIFS). For example, since the XIFS is an IFS used in the preemption operation, it may be referred to as a preemption (Pr) IFS, or the like. In other words, the XIFS may be used for the preemption operation. The XIFS may be referred to as an LL IFS or Pr IFS. The XIFS may be set independently of other IFSs (e.g., SIFS). The length of XIFS may be longer than the length of SIFS. For example, the length of XIFS may be equal to a priority interframe space (PIFS), arbitrary interframe space (AIFS), distributed coordination function interframe space (DIFS), or the like, which is longer than the SIFS. Alternatively, the length of XIFS may be less than or equal to the length of SIFS. The final PPDU field may include information indicating whether a PPDU (e.g., frame) including the final PPDU field is a final PPDU (e.g., the last frame). The final PPDU field may be referred to as a final frame field. In a block acknowledgment (BA) scheme, transmission of a BA frame may be needed after transmission of a final PPDU, and transmission of a BA frame may not be needed after transmission of a PPDU other than a final PPDU. Therefore, the final PPDU field may be interpreted as information indicating whether transmission of a response frame is requested for the frame (e.g., the final frame) transmitted by the AP. In the present disclosure, the response frame may be an acknowledgement (ACK) frame or a BA frame.

The size of the final PPDU field may be 1 bit. A first value (e.g., 0) of the final PPDU field may indicate that a PPDU including the final PPDU field is not a final PPDU. If the current PPDU is not a final PPDU, transmission of a response frame for the current PPDU may not be needed. In other words, the first value (e.g., 0) of the final PPDU field may indicate that transmission of a response frame for the frame is not required. If the final PPDU field is set to the first value, the STA may not transmit a response frame after an SIFS or XIFS from a reception time of the frame.

If the PPDU including the final PPDU field is an LL PPDU, the interpretation of the value of the final PPDU field may be different. The LL PPDU may include LL traffic. Transmission of the LL PPDU may be performed between PPDU transmissions that are not LL PPDU transmissions. In the above-described situation, the final PPDU field of the LL PPDU may be set to the first value (e.g., 0). In other words, since transmission of the LL PPDU is not transmission of the final PPDU among PPDU transmissions, the final PPDU field of the LL PPDU may be set to the first value (e.g., 0). When the final PPDU field of the LL PPDU is set to the first value (e.g., 0), a response frame for the LL PPDU may be transmitted after an IFS (e.g., SIFS or XIFS) from a transmission end time of the LL PPDU.

A second value (e.g., 1) of the final PPDU field may indicate that the PPDU including the final PPDU field is a final PPDU. If the current PPDU is a final PPDU, transmission of a response frame for the current PPDU may be required. In other words, the second value (e.g., 1) of the final PPDU field may indicate that transmission of a response frame for the frame (e.g., the final frame) is required. If the final PPDU field is set to the second value, the STA may transmit a response frame to the AP after an SIFS or XIFS from a reception time of the frame (e.g., the final frame).

The RBO CW field may include parameters (e.g., information) for collision avoidance in the preemption operation. For example, the RBO CW field may include information on a CW size for the preemption operation. The maximum time field may include information indicating the maximum time (e.g., the length of the maximum time) during which transmission according to the preemption operation is possible. The communication node (e.g., STA and/or AP) performing the preemption operation may not be able to perform frame transmission (e.g., LL traffic transmission) exceeding the maximum time indicated by the maximum time field. If a time required for transmission of the LL traffic (e.g., LL frame) to be transmitted exceeds the maximum time, the transmission of the LL traffic may not be performed. Alternatively, the maximum time field may indicate the maximum size of transmittable data instead of the maximum time. The maximum size of transmittable data may be indicated in units of bytes (e.g., octets). For example, the communication node performing the preemption operation may not be able to transmit data exceeding the maximum size of transmittable data.

The preemption information (e.g., preemption field, final PPDU field, RBO CW field, and/or maximum time field) may be included in the frame transmitted by the communication node (e.g., AP and/or STA) in various forms (e.g., PHY preamble, information elements, subfields, indication bits). For example, some information element(s) of the preemption information may be included in a PHY preamble, and other information element(s) of the preemption information may be included in a MAC header. When the preemption information is included in a frame, an XIFS may be used for transmission of the frame. For example, the XIFS may be used for transmission of the frame including the preemption information. When the preemption information is not included in a frame, an IFS (e.g., SIFS) other than the XIFS may be used for transmission of the frame. For example, the SIFS may be used for transmission of the frame not including the preemption information.

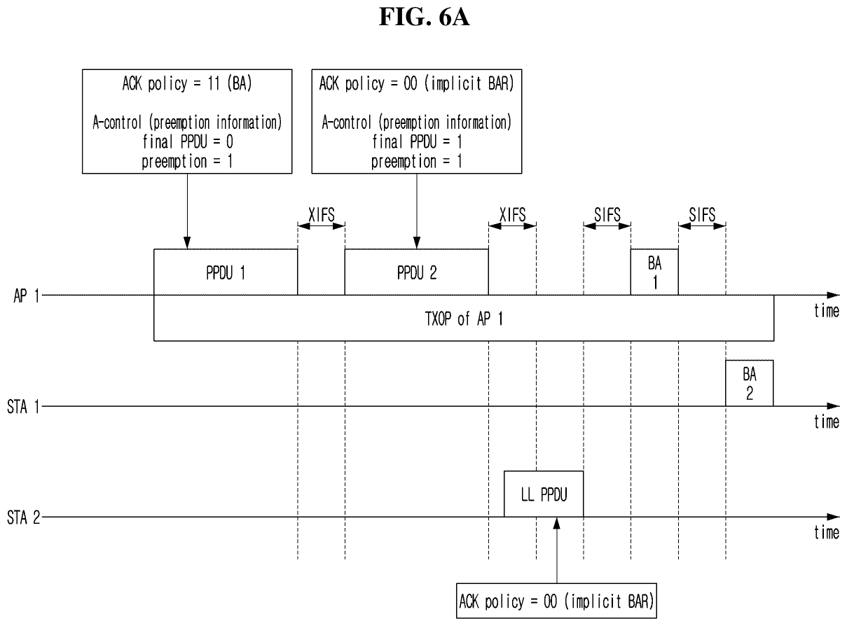

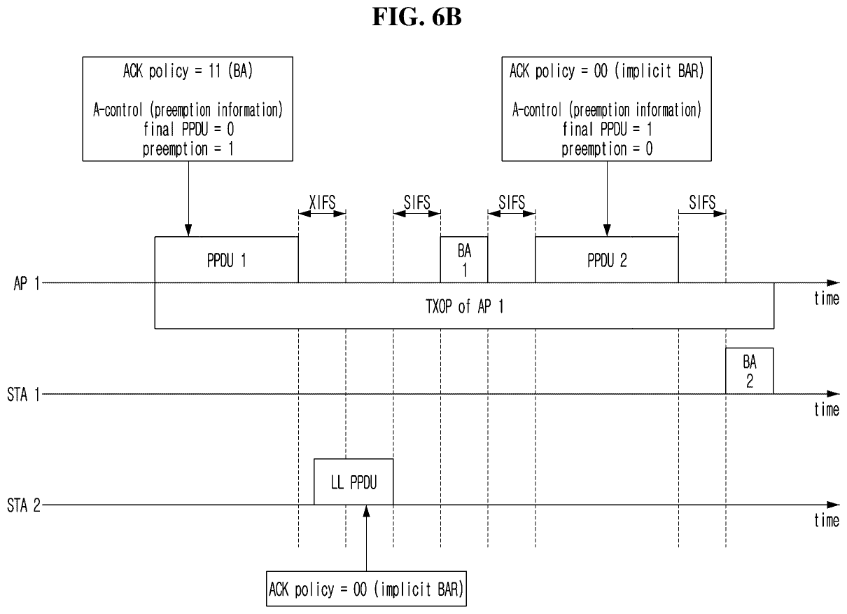

FIGS. 6A and 6B are timing diagrams illustrating exemplary embodiments of a preemption method.

Referring to FIGS. 6A and 6B, an AP 1, STA 1, and STA 2 may operate in a wireless LAN. The STA 1 and/or STA 2 may be associated with (e.g., access) the AP 1. Each of the AP 1, STA 1, and STA 2 may receive a frame transmitted from another communication node, and may identify information (e.g., preemption information) included in the frame. For example, the STA 1 may receive a frame in which a destination (e.g., recipient) is set to the STA 2, and may identify information included in the frame. The STA 2 may receive a frame in which a destination (e.g., recipient) is set to the STA 1, and may identify information included in the frame. In other words, each STA may identify information included in frame(s) in which a destination is not set to itself.

The AP 1 may obtain a transmit opportunity (TXOP) by performing a backoff operation (e.g., enhanced distributed channel access (EDCA) backoff operation). The backoff operation may be a channel access operation, and the TXOP may be obtained when the channel access operation succeeds. The AP 1 may transmit one or more frames within the TXOP. Each of the one or more frames may be a PPDU, MPDU, and/or A-MPDU. The PPDU transmitted by the AP 1 may include one or more A-MPDUs or one or more MPDUs. The frame transmitted by the AP 1 may include preemption information and/or data (e.g., traffic). In other words, the frame transmitted by the AP 1 may include a MAC header including the preemption information as illustrated in FIG. 5. Alternatively, the frame transmitted by the AP 1 may include a PHY header (e.g., preamble) including the preemption information as illustrated in FIG. 5. Both the PHY header and the MAC header of the frame transmitted by the AP 1 may include the preemption information as illustrated in FIG. 5.

The preemption information may be included in the frame transmitted by the AP 1 in a HT control field of the MAC header in an A-control form. The preemption information may be included in the frame transmitted by the AP 1 in various forms (e.g., PHY preamble, information elements, subfields, indication fields). In the exemplary embodiments of FIG. 6A and/or FIG. 6B, the frame transmitted by the AP 1 may include the preemption information in an A-control form. In other words, the preemption information may be indicated in an A-control form. Even when the preemption information is not indicated in an A-control form (e.g., even when the preemption information is included in the PHY preamble of the frame), the communication node (e.g., AP 1, STA 1, STA 2) may perform a preemption operation (e.g., priority transmission operation) identically or similarly to the exemplary embodiments of FIG. 6A and/or FIG. 6B.

In the exemplary embodiment of FIG. 6A, the AP 1 may transmit a PPDU 1 (e.g., DL PPDU 1, data frame) to the STA 1. A destination (e.g., recipient) of the PPDU 1 may be the STA 1. The PPDU 1 (e.g., MAC header of an MPDU (A-MPDU) included in the PPDU 1) may include preemption information. The STA 1 may receive the PPDU 1 from the AP 1 and identify the preemption information included in the PPDU 1. The preemption information may include at least one of a preemption field, a final PPDU field, an RBO CW field, or a maximum time field. The final PPDU field included in the PPDU 1 may be set to a first value (e.g., 0). If the final PPDU field is set to the first value (e.g., 0), the STA 1 may not immediately transmit a response frame for the PPDU 1 (e.g., PPDU 1 including the final PPDU field set to the first value) to the AP 1. The transmitting the response frame immediately may mean transmitting the response frame after an SIFS from a reception completion time of the PPDU. The response frame transmitted after the SIFS may be an immediate response frame.

The preemption field included in the PPDU 1 may be set to a second value (e.g., 1). The preemption field set to the second value (e.g., 1) may indicate that an interval between the PPDU 1 and the next frame is an XIFS and/or that the preemption operation is allowed. The PPDU 1 (e.g., MAC header of the MPDU (A-MPDU) included in the PPDU 1) may include a quality of service (QoS) control field, and the QoS control field may include ACK policy information (e.g., ACK policy field). The ACK policy information of the PPDU 1 (e.g., ACK policy information set to 11) may indicate a block ACK. The ACK policy information of the PPDU 1 indicating a block ACK may indicate that a response frame for the PPDU 1 does not need to be transmitted immediately. The ACK policy information of the PPDU 1 may be included in the MAC header of the MPDU (A-MPDU) included in the PPDU 1.

The STA 2 may receive the PPDU 1 transmitted by the AP 1, and identify the information (e.g., preemption information) included in the PPDU 1. For example, the STA 2 may determine that the preemption operation is allowed based on the information included in the PPDU 1. During an XIFS from a transmission end time of the PPDU 1, an LL STA (e.g., STA 2) may not perform transmission. For example, if LL traffic does not exist in the STA 2 (e.g., if LL traffic does not occur in the STA 2), the STA 2 may not transmit an LL PPDU (e.g., LL PPDU including LL traffic) during an XIFS from the transmission end time of the PPDU 1. Since there is no transmission from another communication node (e.g., STA 2) during an XIFS from the transmission end time of the PPDU 1, the AP 1 may transmit a PPDU 2 (e.g., DL PPDU 2, data frame) to the STA 1 after or within an XIFS from the transmission end time of the PPDU 1. A destination (e.g., recipient) of the PPDU 2 may be the STA 1. The PPDU 2 (e.g., MAC header of an MPDU (A-MPDU) included in the PPDU 2) may include preemption information. The STA 1 may receive the PPDU 2 from the AP 1 and may identify the preemption information included in the PPDU 2.

The final PPDU field included in the PPDU 2 may be set to a second value (e.g., 1). When the final PPDU field is set to the second value (e.g., 1), the STA 1 may transmit a response frame (e.g., BA 2) for the PPDU 2 (e.g., PPDU 2 including the final PPDU field set to the second value) to the AP 1. The preemption field included in the PPDU 2 may be set to a second value (e.g., 1). The preemption field set to the second value (e.g., 1) may indicate that an interval between the PPDU 2 and the next frame is an XIF S and/or that the preemption operation is allowed. The PPDU 2 (e.g., MAC header of the MPDU (A-MPDU) included in the PPDU 2) may include a QoS control field, and the QoS control field may include ACK policy information (e.g., ACK Policy field). The ACK policy information of the PPDU 2 (e.g., ACK policy information set to 00) may indicate an implicit block ack request (BAR). The ACK policy information of the PPDU 2 indicating an implicit BAR may indicate that a response frame for the PPDU 2 needs to be transmitted immediately. The ACK policy information of the PPDU 2 may be included in the MAC header of the MPDU (A-MPDU) included in the PPDU 2.

The STA 2 may receive the PPDU 2 transmitted by the AP 1, and may identify information (e.g., preemption information) included in the PPDU 2. For example, the STA 2 may determine that the preemption operation is allowed based on the information included in the PPDU 2. If LL traffic exists in the STA 2 (e.g., if LL traffic occurs in the STA 2), the STA 2 may transmit an LL PPDU (e.g., UL LL PPDU, LL data, LL frame) to the AP 1 within an XIFS from a transmission end time of the PPDU 2. The AP 1 may receive the LL PPDU from the STA 2. The LL PPDU may include the LL traffic.

The LL PPDU (e.g., MAC header of the MPDU (A-MPDU) included in the LL PPDU) may include a QoS control field, and ACK policy information included in the QoS control field (e.g., ACK policy information set to 00) may indicate an implicit BAR. If the ACK policy information of the LL PPDU indicates the implicit BAR, the AP 1 may transmit a response frame (e.g., BA 1) for the LL PPDU to the STA 2 after an SIFS from a reception end time of the LL PPDU. The STA 2 may receive the response frame (e.g., BA 1) for the LL PPDU from the AP 1. Alternatively, the AP 1 may not identify the ACK policy information of the LL PPDU, and may transmit a response frame (e.g., BA 1) for the LL PPDU to the STA 2 after an SIFS from the reception end time of the LL PPDU. In other words, the response frame (e.g., BA 1) for the LL PPDU may be transmitted without checking the ACK policy information.

If transmission of the LL traffic (e.g., transmission of the LL PPDU of the STA 2) according to the preemption operation is performed during communication between the AP 1 and the STA 1, the communication between the AP 1 and the STA 1 may be delayed. For example, the communication (e.g., frame transmission) between the STA 1 and the AP 1 may be completed after transmission of the LL PPDU and/or response frame for the LL PPDU is completed. In other words, the response frame (e.g., BA 2) for the PPDU 1 and the PPDU 2 may be transmitted after transmission of the response frame (e.g., BA 1) for the LL PPDU is completed.

In the exemplary embodiment of FIG. 6B, the AP 1 may transmit the PPDU 1 (e.g., DL PPDU 1, data frame) to the STA 1. A destination (e.g., recipient) of the PPDU 1 may be the STA 1. The PPDU 1 (e.g., MAC header of an MPDU (A-MPDU) included in the PPDU 1) may include preemption information. The STA 1 may receive the PPDU 1 from the AP 1 and identify the preemption information included in the PPDU 1. The preemption information may include at least one of a preemption field, a final PPDU field, an RBO CW field, or a maximum time field. The final PPDU field included in the PPDU 1 may be set to a first value (e.g., 0). If the final PPDU field is set to the first value (e.g., 0), the STA 1 may not immediately transmit a response frame for the PPDU 1 (e.g., PPDU 1 including the final PPDU field set to the first value) to the AP 1.

The preemption field included in the PPDU 1 may be set to a second value (e.g., 1). The preemption field set to the second value (e.g., 1) may indicate that an interval between the PPDU 1 and the next frame is an XIFS and/or that the preemption operation is allowed. The PPDU 1 (e.g., MAC header of the MPDU (A-MPDU) included in the PPDU 1) may include a QoS control field, and the QoS control field may include ACK policy information (e.g., ACK policy field). The ACK policy information of the PPDU 1 (e.g., ACK policy information set to 11) may indicate a block ACK. The ACK policy information of the PPDU 1 indicating the block ACK may indicate that a response frame for the PPDU 1 does not need to be transmitted immediately.

The STA 2 may receive the PPDU 1 transmitted by the AP 1 and identify information included in the PPDU 1 (e.g., preemption information). For example, the STA 2 may determine that the preemption operation is allowed based on the information included in the PPDU 1. If LL traffic exists in the STA 2 (e.g., LL traffic occurs in the STA 2), the STA 2 may transmit an LL PPDU (e.g., UL LL PPDU, LL data, LL frame) to the AP 1 within an XIFS from a transmission end time of the PPDU 1. The AP 1 may receive the LL PPDU from the STA 2. The LL PPDU may include the LL traffic. The LL PPDU (e.g., MAC header of an MPDU (A-MPDU) included in the LL PPDU) may include a QoS control field, and ACK policy information included in the QoS control field (e.g., ACK policy information set to 00) may indicate an implicit BAR.

If the ACK policy information of the LL PPDU indicates an implicit BAR, the AP 1 may transmit a response frame (e.g., BA 1) for the LL PPDU to the STA 2 after an SIFS from a reception end time of the LL PPDU. The STA 2 may receive the response frame (e.g., BA 1) for the LL PPDU from the AP 1. Alternatively, the AP 1 may not identify the ACK policy information of the LL PPDU, and may transmit a response frame (e.g., BA 1) for the LL PPDU to the STA 2 after an SIFS from the reception end time of the LL PPDU. In other words, the response frame (e.g., BA 1) for the LL PPDU may be transmitted without checking the ACK policy information.

After an SIFS from the transmission end time of the response frame (e.g., BA 1) for the LL PPDU, the AP 1 may transmit a PPDU 2 (e.g., DL PPDU 2, data frame) to the STA 1. A destination (e.g., recipient) of the PPDU 2 may be the STA 1. The PPDU 2 (e.g., MAC header of an MPDU (A-MPDU) included in the PPDU 2) may include preemption information. The STA 1 may receive the PPDU 2 from the AP 1 and identify the preemption information included in the PPDU 2. A final PPDU field included in the PPDU 2 may be set to a second value (e.g., 1). If the final PPDU field is set to the second value (e.g., 1), the STA 1 may transmit a response frame (e.g., BA 2) for the PPDU 2 (e.g., PPDU 2 including the final PPDU field set to the second value) to the AP 1. The preemption field included in the PPDU 2 may be set to a first value (e.g., 0).

The preemption field set to the first value (e.g., 0) may indicate that an interval between the PPDU 2 and the next frame is an SIFS and/or that the preemption operation is not allowed. The PPDU 2 (e.g., MAC header of the MPDU (A-MPDU) included in the PPDU 2) may include a QoS control field, and the QoS control field may include ACK policy information (e.g., ACK policy field). The ACK policy information of the PPDU 2 (e.g., ACK policy information set to 00) may indicate an implicit BAR. The ACK policy information of the PPDU 1 indicating the implicit BAR may indicate that a response frame for the PPDU 2 needs to be transmitted immediately.

The STA 1 may transmit a response frame (e.g., BA 2) to the AP 1 after an SIFS from a reception end time of the PPDU 2. The response frame (e.g., BA 2) of the STA 1 may be a response frame for the PPDU 1 and the PPDU 2. The AP 1 may receive the response frame (e.g., BA 2) from the STA 1. Alternatively, the preemption field of the PPDU 2 may indicate a second value (e.g., 1). In other words, the preemption field of the PPDU 2 may indicate that an interval between the PPDU 2 and the next frame is an XIFS and/or that the preemption operation is allowed. In this case, the STA 1 may transmit a response frame (e.g., BA 2) to the AP 1 after an XIFS from the reception end time of the PPDU 2. The response frame of the STA 1 (e.g., BA 2) may be transmitted if there is no frame transmission (e.g., transmission of LL frame) from another communication node (e.g., LL STA) during an XIFS from the reception end time of the PPDU 2.

If transmission of LL traffic (e.g., transmission of the LL PPDU of the STA 2) by the preemption operation is performed during communication between the AP 1 and the STA 1, the communication between the AP 1 and the STA 1 may be delayed. For example, the communication (e.g., frame transmission) between the STA 1 and the AP 1 may be completed after transmission of the LL PPDU and/or response frame for the LL PPDU is completed.

In the exemplary embodiments of FIG. 6A and/or FIG. 6B, the STA 1 may not detect communication (e.g., frame transmission) of the STA 2. In other words, the STA 2 may be a hidden node with respect to the STA 1. In order to solve the problem of the hidden node, the STA 2 may preferentially transmit a request-to-send (RTS) frame to the AP 1 before transmission of the LL PPDU. The RTS frame may include information indicating that the preemption operation is performed. The AP 1 may receive the RTS frame from the STA 2, and transmit a clear-to-send (CTS) frame to the STA 2 in response to the RTS frame. The CTS frame may include information indicating that the preemption operation is performed.

The CTS frame may be transmitted after an SIFS from a reception completion time of the RTS frame. The STA 2 may receive the CTS frame from the AP 1, and transmit the LL PPDU to the AP 1 after an SIFS from the reception end time of the CTS frame. The STA 1 may not receive the RTS frame of the STA 2, but may receive the CTS frame of the AP 1. The STA 1 may identify that communication of another communication node (e.g., transmission of LL traffic of the STA 2) is performed based on the RTS frame and/or the CTS frame. Therefore, while the STA 2 transmits the LL PPDU, the STA 1 may not transmit a frame to the AP 1. A duration field included in a MAC header of the RTS frame and the CTS frame may indicate a sufficient time for the LL PPDU (e.g., LL traffic) to be transmitted. The time indicated by the duration field included in the MAC header of the RTS frame and the CTS frame may not exceed a time indicated by the maximum time field of the preemption information illustrated in FIG. 5.

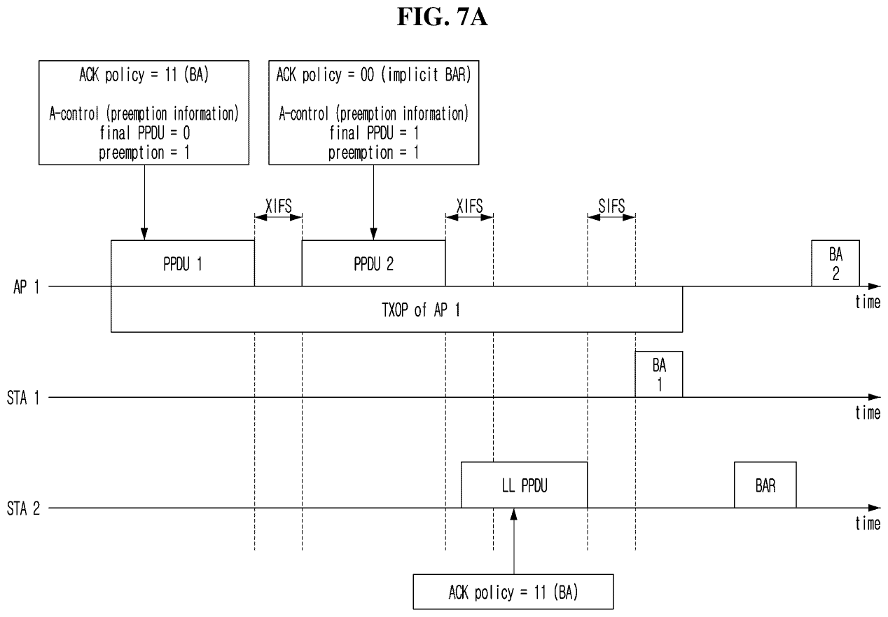

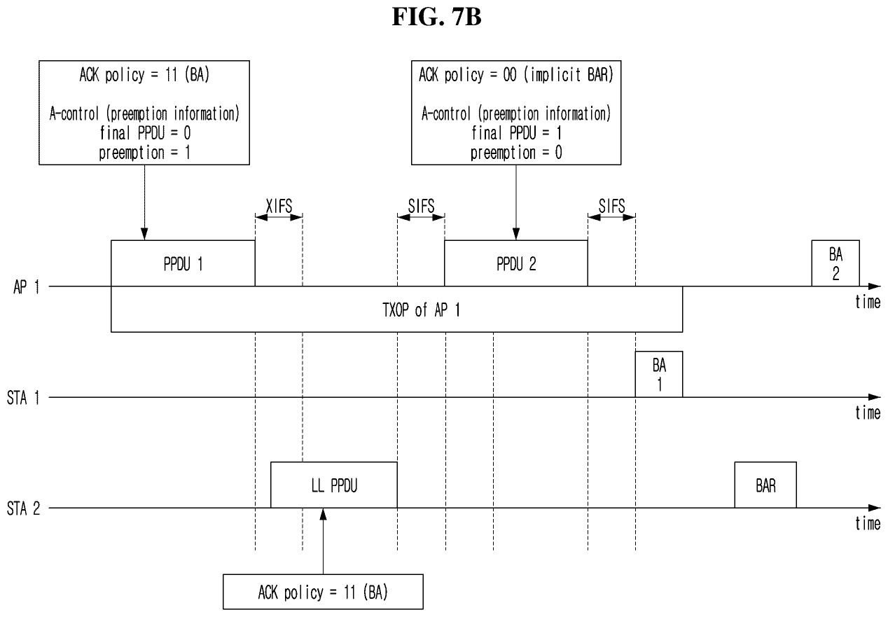

FIGS. 7A and 7B are timing diagrams illustrating exemplary embodiments of a preemption method.

Referring to FIGS. 7A and 7B, an AP 1, STA 1, and STA 2 may operate in a wireless LAN. The STA 1 and/or STA 2 may be associated with (e.g., access) the AP 1. Each of the AP 1, STA 1, and STA 2 may receive a frame transmitted from another communication node and may identify information (e.g., preemption information) included in the frame. For example, the STA 1 may receive a frame in which a destination (e.g., recipient) is set to the STA 2 and may identify information included in the frame. The STA 2 may receive a frame in which a destination (e.g., recipient) is set to the STA 1 and may identify information included in the frame.

The AP 1 may obtain a TXOP by performing a backoff operation (e.g., EDCA backoff operation). The backoff operation may be a channel access operation, and the TXOP may be obtained when the channel access operation succeeds. The AP 1 may transmit one or more frames within the TXOP. Each of the one or more frames may be a PPDU, an MPDU, and/or an A-MPDU. The PPDU transmitted by the AP 1 may include one or more A-MPDUs or one or more MPDUs. The frame transmitted by the AP 1 may include preemption information and/or data (e.g., traffic). In other words, the frame transmitted by the AP 1 may include a MAC header including the preemption information as illustrated in FIG. 5. Alternatively, the frame transmitted by the AP 1 may include a PHY header (e.g., preamble) including the preemption information as illustrated in FIG. 5. Both the PHY header and the MAC header of the frame transmitted by AP 1 may include the preemption information as illustrated in FIG. 5.

The preemption information may be included in the frame transmitted by the AP 1 in a HT control field of the MAC header in an A-control form. The preemption information may be included in the frame transmitted by the AP 1 in various forms (e.g., PHY preamble, information elements, subfields, indication fields). In the exemplary embodiments of FIG. 7A and/or FIG. 7B, the frame transmitted by the AP 1 may include the preemption information in an A-control form. In other words, the preemption information may be indicated in an A-control form. Even when the preemption information is not indicated in an A-control form (e.g., even when the preemption information is included in the PHY preamble of the frame), the communication node (e.g., AP 1, STA 1, STA 2) may perform the preemption operation (e.g., priority transmission operation) identically or similarly to the exemplary embodiments of FIG. 7A and/or FIG. 7B.

In the exemplary embodiment of FIG. 7A, the AP 1 may transmit a PPDU 1 (e.g., DL PPDU 1, data frame) to the STA 1. A destination (e.g., recipient) of the PPDU 1 may be the STA 1. The PPDU 1 (e.g., MAC header of an MPDU (A-MPDU) included in the PPDU 1) may include preemption information. The STA 1 may receive the PPDU 1 from the AP 1 and identify the preemption information included in the PPDU 1. The preemption information may include at least one of a preemption field, a final PPDU field, an RBO CW field, or a maximum time field. The final PPDU field included in the PPDU 1 may be set to a first value (e.g., 0). If the final PPDU field is set to the first value (e.g., 0), the STA 1 may not immediately transmit a response frame for the PPDU 1 (e.g., PPDU 1 including the final PPDU field set to the first value) to the AP 1.

The preemption field included in the PPDU 1 may be set to a second value (e.g., 1). The preemption field set to the second value (e.g., 1) may indicate that an interval between the PPDU 1 and the next frame is an XIFS and/or that the preemption operation is allowed. The PPDU 1 (e.g., MAC header of an MPDU (A-MPDU) included in the PPDU 1) may include a QoS control field, and the QoS control field may include ACK policy information (e.g., ACK policy field). The ACK policy information of the PPDU 1 (e.g., ACK policy information set to 11) may indicate a block ACK. The ACK policy information of the PPDU 1 indicating the block ACK may indicate that a response frame for the PPDU 1 does not need to be transmitted immediately. The ACK policy information of the PPDU 1 may be included in the MAC header of the MPDU (A-MPDU) included in the PPDU 1.

The STA 2 may receive the PPDU 1 transmitted by the AP 1 and identify the information (e.g., preemption information) included in the PPDU 1. For example, the STA 2 may determine that the preemption operation is allowed based on the information included in the PPDU 1. During an XIFS from a transmission end time of the PPDU 1, an LL STA (e.g., STA 2) may not perform transmission. For example, if LL traffic does not exist in the STA 2 (e.g., if LL traffic does not occur in the STA 2), the STA 2 may not transmit an LL PPDU (e.g., LL PPDU including LL traffic) during an XIFS from the transmission end time of the PPDU 1. Since there is no transmission from another communication node (e.g., STA 2) during an XIFS from the transmission end time of the PPDU 1, the AP 1 may transmit a PPDU 2 (e.g., DL PPDU 2, data frame) to the STA 1 after or within an XIFS from the transmission end time of the PPDU 1. A destination (e.g., recipient) of the PPDU 2 may be the STA 1. The PPDU 2 (e.g., MAC header of an MPDU (A-MPDU) included in the PPDU 2) may include preemption information. The STA 1 may receive the PPDU 2 from the AP 1 and identify the preemption information included in the PPDU 2.

The final PPDU field included in the PPDU 2 may be set to a second value (e.g., 1). If the final PPDU field is set to the second value (e.g., 1), the STA 1 may transmit a response frame (e.g., BA 1) for the PPDU 2 (e.g., PPDU 2 including the final PPDU field set to the second value) to the AP 1. The preemption field included in the PPDU 2 may be set to a second value (e.g., 1). The preemption field set to the second value (e.g., 1) may indicate that an interval between the PPDU 2 and the next frame is an XIF S and/or that the preemption operation is allowed. The PPDU 2 (e.g., MAC header of the MPDU (A-MPDU) included in the PPDU 2) may include a QoS control field, and the QoS control field may include ACK policy information (e.g., ACK policy field). The ACK policy information of the PPDU 2 (e.g., ACK policy information set to 00) may indicate an implicit BAR. The ACK policy information of the PPDU 1 indicating the implicit BAR may indicate that a response frame for the PPDU 2 needs to be transmitted immediately.

The STA 2 may receive the PPDU 2 transmitted by the AP 1 and identify the information included in the PPDU 2 (e.g., preemption information). For example, the STA 2 may determine that the preemption operation is allowed based on the information included in the PPDU 2. If LL traffic exists in the STA 2 (e.g., if LL traffic occurs in the STA 2), the STA 2 may transmit an LL PPDU (e.g., UL LL PPDU, LL data, LL frame) to the AP 1 within an XIFS from a transmission end time of the PPDU 2. The AP 1 may receive the LL PPDU from the STA 2. The LL PPDU may include the LL traffic. The LL PPDU (e.g., MAC header of an MPDU (A-MPDU) included in the LL PPDU) may include a QoS control field, and ACK policy information (e.g., ACK policy information set to 11) included in the QoS control field may indicate a block ACK. If the ACK policy information of the LL PPDU indicates the block ACK, the AP 1 may not immediately transmit a response frame (e.g., BA 2) for the LL PPDU. Alternatively, the AP 1 may not immediately transmit a response frame (e.g., BA 2) for the LL PPDU without checking the ACK policy information of the LL PPDU.

When transmission of the LL PPDU of the STA 2 is performed, the STA 1 may not transmit a response frame (e.g., BA 1) for the PPDU 1 and the PPDU 2. Transmission of the response frame (e.g., BA 1) for the PPDU 1 and the PPDU 2 may be delayed by transmission of the LL PPDU. The STA 1 may transmit the response frame (e.g., BA 1) for the PPDU 1 and the PPDU 2 to the AP 1 after an SIFS from a transmission end time of the LL PPDU. The STA 2 may transmit a BAR frame to the AP 1. The BAR frame may be transmitted after the transmission end time of the response frame (e.g., BA 1) of the STA 1. The BAR frame may request transmission of a response frame (e.g., BA 2) for the LL PPDU of the STA 2. In other words, the BAR frame may be a request frame that requests transmission of the response frame. The AP 1 may receive the BAR frame from the STA 2, and may transmit the response frame (e.g., BA 2) for the LL PPDU to the STA 2 in response to the BAR frame. The STA 2 may receive the response frame (e.g., BA 2) for the LL PPDU from the AP 1.

In the exemplary embodiment of FIG. 7B, the AP 1 may transmit a PPDU 1 (e.g., DL PPDU 1, data frame) to the STA 1. A destination (e.g., recipient) of the PPDU 1 may be the STA 1. The PPDU 1 (e.g., MAC header of an MPDU (A-MPDU) included in the PPDU 1) may include preemption information. The STA 1 may receive the PPDU 1 from the AP 1 and identify the preemption information included in the PPDU 1. The preemption information may include at least one of a preemption field, a final PPDU field, an RBO CW field, or a maximum time field. The final PPDU field included in the PPDU 1 may be set to a first value (e.g., 0). If the final PPDU field is set to the first value (e.g., 0), the STA 1 may not immediately transmit a response frame for the PPDU 1 (e.g., PPDU 1 including the final PPDU field set to the first value) to the AP 1.

The preemption field included in the PPDU 1 may be set to a second value (e.g., 1). The preemption field set to the second value (e.g., 1) may indicate that an interval between the PPDU 1 and the next frame is an XIFS and/or that the preemption operation is allowed. The PPDU 1 (e.g., MAC header of the MPDU (A-MPDU) included in the PPDU 1) may include a QoS control field, and the QoS control field may include ACK policy information (e.g., ACK policy field). The ACK policy information of the PPDU 1 (e.g., ACK policy information set to 11) may indicate a block ACK. The ACK policy information of the PPDU 1 indicating the block ACK may indicate that a response frame for the PPDU 1 does not need to be transmitted immediately. The ACK policy information of the PPDU 1 may be included in the MAC header of the MPDU (A-MPDU) included in the PPDU 1.

The STA 2 may receive the PPDU 1 transmitted by the AP 1, and identify the information included in the PPDU 1 (e.g., preemption information). For example, the STA 2 may determine that the preemption operation is allowed based on the information included in the PPDU 1. If LL traffic exists in the STA 2 (e.g., if LL traffic occurs in the STA 2), the STA 2 may transmit an LL PPDU (e.g., UL LL PPDU, LL data, LL frame) to the AP 1 within an XIFS from a transmission end time of the PPDU 1. The AP 1 may receive the LL PPDU from the STA 2. The LL PPDU may include the LL traffic. The LL PPDU (e.g., MAC header of an MPDU (A-MPDU) included in the LL PPDU) may include a QoS control field, and ACK policy information included in the QoS control field (e.g., ACK policy information set to 11) may indicate a block ACK. If the ACK policy information of the LL PPDU indicates the block ACK, the AP 1 may not immediately transmit a response frame (e.g., BA 2) for the LL PPDU. Alternatively, the AP 1 may not immediately transmit the response frame (e.g., BA 2) for the LL PPDU without checking the ACK policy information of the LL PPDU.

After an SIFS from a reception end time of the LL PPDU, the AP 1 may transmit a PPDU 2 (e.g., DL PPDU 2, data frame) to the STA 1. Transmission of the PPDU 2 may be delayed by transmission of the LL PPDU. A destination (e.g., recipient) of the PPDU 2 may be the STA 1. The PPDU 2 (e.g., MAC header of an MPDU (A-MPDU) included in the PPDU 2) may include preemption information. The STA 1 may receive the PPDU 2 from the AP 1 and identify the preemption information included in the PPDU 2. The final PPDU field included in the PPDU 2 may be set to a second value (e.g., 1). If the final PPDU field is set to the second value (e.g., 1), the STA 1 may transmit a response frame (e.g., BA 1) for the PPDU 2 (e.g., PPDU 2 including the final PPDU field set to the second value) to the AP 1.

The preemption field included in the PPDU 2 may be set to a first value (e.g., 0). The preemption field set to the first value (e.g., 0) may indicate that an interval between the PPDU 2 and the next frame is an SIFS and/or that the preemption operation is not allowed. The PPDU 2 (e.g., MAC header of the MPDU (A-MPDU) included in the PPDU 2) may include a QoS control field, and the QoS control field may include ACK policy information (e.g., ACK policy field). The ACK policy information of the PPDU 2 (e.g., ACK policy information set to 00) may indicate an implicit BAR. The ACK policy information of the PPDU 2 indicating the implicit BAR may indicate that a response frame for the PPDU 2 needs to be transmitted immediately. The ACK policy information of the PPDU 2 may be included in the MAC header of the MPDU (A-MPDU) included in the PPDU 2.

The STA 1 may transmit a response frame (e.g., BA 1) to the AP 1 after an SIFS from a reception end time of the PPDU 2. The response frame (e.g., BA 1) of the STA 1 may be a response frame for the PPDU 1 and the PPDU 2. The AP 1 may receive the response frame (e.g., BA 1) from the STA 1. Alternatively, the preemption field of the PPDU 2 may indicate a second value (e.g., 1). In other words, the preemption field of the PPDU 2 may indicate that an interval between the PPDU 2 and the next frame is an XIFS and/or that the preemption operation is allowed. In this case, the STA 1 may transmit the response frame (e.g., BA 1) to the AP 1 after an XIFS from the reception end time of the PPDU 2. The response frame of the STA 1 (e.g., BA 1) may be transmitted if there is no frame transmission (e.g., transmission of LL frame) of another communication node (e.g., LL STA) during an XIFS from the reception end time of the PPDU 2.

The STA 2 may transmit a BAR frame (e.g., request frame for a block ACK frame which is a response frame) to the AP 1. The BAR frame may be transmitted after a transmission end time of the response frame of the STA 1 (e.g., BA 1). The BAR frame may request transmission of a response frame (e.g., BA 2) for the LL PPDU of the STA 2. The AP 1 may receive the BAR frame from the STA 2, and transmit the response frame (e.g., BA 2) for the LL PPDU to the STA 2 in response to the BAR frame. The STA 2 may receive the response frame (e.g., BA 2) for the LL PPDU from the AP 1.

In the exemplary embodiments of FIG. 7A and/or FIG. 7B, when transmission of the LL traffic (e.g., transmission of the LL PPDU of the STA 2) by the preemption operation is performed during communication between the AP 1 and the STA 1, the communication between the AP 1 and the STA 1 may be delayed. For example, the communication (e.g., frame transmission) between the STA 1 and the AP 1 may be completed after transmission of the LL PPDU and/or response frame for the LL PPDU is completed.

The STA 1 may not detect communication (e.g., frame transmission) of the STA 2. In other words, the STA 2 may be a hidden node with respect to the STA 1. To solve the problem of the hidden node, the STA 2 may preferentially transmit an RTS frame to the AP 1 before transmitting the LL PPDU. The RTS frame may include information indicating that the preemption operation is performed. The AP 1 may receive the RTS frame from the STA 2 and transmit a CTS frame to the STA 2 in response to the RTS frame. The CTS frame may include information indicating that the preemption operation is performed.

The CTS frame may be transmitted after an SIFS after a reception completion time of the RTS frame. The STA 2 may receive the CTS frame from the AP 1 and transmit the LL PPDU to the AP 1 after an SIFS from a reception end time of the CTS frame. The STA 1 may not receive the RTS frame of the STA 2, but may receive the CTS frame of the AP 1. The STA 1 may determine that communication of another communication node (e.g., transmission of the LL traffic of the STA 2) is performed based on the RTS frame and/or the CTS frame. Therefore, the STA 1 may not transmit a frame to the AP 1 while the STA 2 transmits the LL PPDU. A duration field included in a MAC header of the RTS frame and the CTS frame may indicate a sufficient time for the LL PPDU (e.g., LL traffic) to be transmitted. The time indicated by the duration field included in the MAC header of the RTS frame and the CTS frame may not exceed a time indicated by the maximum time field of the preemption information illustrated in FIG. 5.

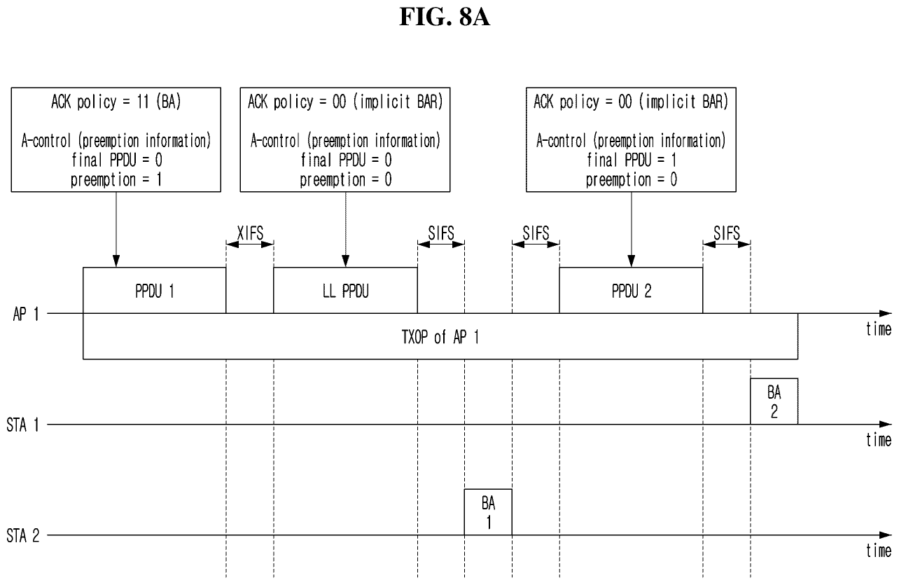

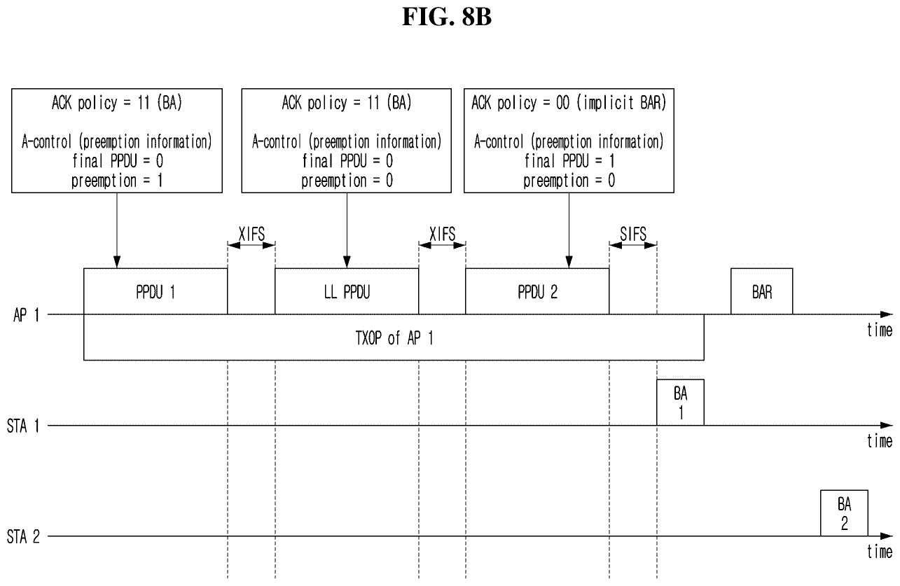

FIG. 8A and FIG. 8B are timing diagrams illustrating exemplary embodiments of a preemption method.

Referring to FIGS. 8A and 8B, an AP 1, STA 1, and STA 2 may operate in a wireless LAN. The STA 1 and/or STA 2 may be associated with (e.g., access) the AP 1. Each of the AP 1, STA 1, and STA 2 may receive a frame transmitted from another communication node, and may identify information (e.g., preemption information) included in the frame. For example, the STA 1 may receive a frame in which a destination (e.g., recipient) is set to the STA 2, and may identify information included in the frame. The STA 2 may receive a frame in which a destination (e.g., recipient) is set to the STA 1, and may identify information included in the frame.

The AP 1 may obtain a TXOP by performing a backoff operation (e.g., EDCA backoff operation). The backoff operation may be a channel access operation, and the TXOP may be obtained when the channel access operation succeeds. The AP 1 may transmit one or more frames within the TXOP. Each of the one or more frames may be a PPDU, an MPDU, and/or an A-MPDU. The PPDU transmitted by the AP 1 may include one or more A-MPDUs or one or more MPDUs. The frame transmitted by the AP 1 may include preemption information and/or data (e.g., traffic). In other words, the frame transmitted by the AP 1 may include a MAC header including the preemption information as illustrated in FIG. 5. Alternatively, the frame transmitted by the AP 1 may include a PHY header (e.g., preamble) including the preemption information as illustrated in FIG. 5. Both the PHY header and the MAC header of the frame transmitted by the AP 1 may include the preemption information as illustrated in FIG. 5.

The preemption information may be included in the frame transmitted by the AP 1 in a HT control field of the MAC header in an A-control form. The preemption information may be included in the frame transmitted by the AP 1 in various forms (e.g., PHY preamble, information elements, subfields, indication fields). In the exemplary embodiments of FIG. 8A and/or FIG. 8B, the frame transmitted by the AP 1 may include the preemption information in an A-control form. In other words, the preemption information may be indicated in an A-control form. Even when the preemption information is not indicated in an A-control form (e.g., even when the preemption information is included in the PHY preamble of the frame), the communication node (e.g., AP 1, STA 1, STA 2) may perform a preemption operation (e.g., priority transmission operation) identically or similarly to the exemplary embodiments of FIG. 8A and/or FIG. 8B.

In the exemplary embodiment of FIG. 8A, the AP 1 may transmit a PPDU 1 (e.g., DL PPDU 1, data frame) to the STA 1. A destination (e.g., recipient) of the PPDU 1 may be the STA 1. The PPDU 1 (e.g., a MAC header of an MPDU (A-MPDU) included in the PPDU 1) may include preemption information. The STA 1 may receive the PPDU 1 from the AP 1 and identify the preemption information included in the PPDU 1. The preemption information may include at least one of a preemption field, a final PPDU field, an RBO CW field, or a maximum time field. The final PPDU field included in the PPDU 1 may be set to a first value (e.g., 0). If the final PPDU field is set to the first value (e.g., 0), the STA 1 may not immediately transmit a response frame for the PPDU 1 (e.g., PPDU 1 including the final PPDU field set to the first value) to the AP 1.

The preemption field included in the PPDU 1 may be set to a second value (e.g., 1). The preemption field set to the second value (e.g., 1) may indicate that an interval between the PPDU 1 and the next frame is an XIFS and/or that the preemption operation is allowed. The PPDU 1 (e.g., MAC header of the MPDU (A-MPDU) included in the PPDU 1) may include a QoS control field, and the QoS control field may include ACK policy information (e.g., ACK policy field). The ACK policy information of the PPDU 1 (e.g., ACK policy information set to 11) may indicate a block ACK. The ACK policy information of the PPDU 1 indicating the block ACK may indicate that a response frame for the PPDU 1 does not need to be transmitted immediately. The ACK policy information of the PPDU 1 may be included in the MAC header of the MPDU (A-MPDU) included in the PPDU 1.

LL traffic to be transmitted to the STA 2 (e.g., LL STA) may occur in the AP 1. In this case, the AP 1 may transmit an LL PPDU (e.g., DL LL PPDU, LL frame, LL data, LL traffic) to the STA 2 after or within an XIFS from a transmission end time of the PPDU 1. Alternatively, the AP 1 may transmit the LL PPDU to the STA 2 after or within an SIFS from the transmission end time of the PPDU 1. The STA 2 may receive the LL PPDU from the AP 1. The LL PPDU (e.g., MAC header of the LL PPDU) may include preemption information. The final PPDU field included in the preemption information may be set to a first value (e.g., 0). The preemption field included in the preemption information may be set to the first value (e.g., 0). The preemption field set to the first value (e.g., 0) may indicate that an interval between the LL PPDU and the next frame is an SIFS and/or that the preemption operation is not allowed.

Alternatively, the LL PPDU (e.g., MAC header of the LL PPDU) may not include preemption information. The LL PPDU (e.g., MAC header of the LL PPDU) may include a QoS control field, and the QoS control field may include ACK policy information. The ACK policy information (e.g., ACK policy information set to 00) may indicate an implicit BAR. The STA 2 may transmit a response frame (e.g., BA 1) for the LL PPDU to the AP 1 after an SIFS from a reception end time of the LL PPDU. The AP 1 may receive the response frame (e.g., BA 1) for the LL PPDU from the STA 2.

After an SIFS from a reception end time of the response frame (e.g., BA 1) for the LL PPDU, the AP 1 may transmit a PPDU 2 (e.g., DL PPDU 2, data frame) to the STA 1. Transmission of the PPDU 2 may be delayed by transmission of the LL PPDU. A destination (e.g., recipient) of the PPDU 2 may be the STA 1. The PPDU 2 (e.g., MAC header of an MPDU (A-MPDU) included in the PPDU 2) may include preemption information. The STA 1 may receive the PPDU 2 from the AP 1 and identify the preemption information included in the PPDU 2. The final PPDU field included in the PPDU 2 may be set to a second value (e.g., 1). If the final PPDU field is set to the second value (e.g., 1), the STA 1 may transmit a response frame (e.g., BA 2) for the PPDU 2 (e.g., PPDU 2 including the final PPDU field set to the second value) to the AP 1.

The preemption field included in the PPDU 2 may be set to a first value (e.g., 0). The preemption field set to the first value (e.g., 0) may indicate that an interval between the PPDU 2 and the next frame is an SIFS and/or that the preemption operation is not allowed. The PPDU 2 (e.g., MAC header of an MPDU (A-MPDU) included in the PPDU 2) may include a QoS control field, and the QoS control field may include ACK policy information (e.g., ACK policy field). The ACK policy information of the PPDU 2 (e.g., ACK policy information set to 00) may indicate an implicit BAR. The ACK policy information of the PPDU 1 indicating the implicit BAR may indicate that a response frame for the PPDU 2 needs to be transmitted immediately. The ACK policy information of the PPDU 2 may be included in the MAC header of the MPDU (A-MPDU) included in the PPDU 2.

After an SIFS from a reception end time of the PPDU 2, the STA 1 may transmit a response frame (e.g., BA 2) for the PPDU 1 and the PPDU 2 to the AP 1. Alternatively, the preemption field included in the PPDU 2 may be set to a second value (e.g., 1). In this case, after an XIFS from the reception end time of the PPDU 2, the STA 1 may transmit the response frame (e.g., BA 2) for the PPDU 1 and the PPDU 2 to the AP 1.

In the exemplary embodiment of FIG. 8B, the AP 1 may transmit a PPDU 1 (e.g., DL PPDU 1, data frame) to the STA 1. A destination (e.g., recipient) of the PPDU 1 may be the STA 1. The PPDU 1 (e.g., MAC header of an MPDU (A-MPDU) included in the PPDU 1) may include preemption information. The STA 1 may receive the PPDU 1 from the AP 1 and identify the preemption information included in the PPDU 1. The preemption information may include at least one of a preemption field, a final PPDU field, an RBO CW field, or a maximum time field. The final PPDU field included in the PPDU 1 may be set to a first value (e.g., 0). If the final PPDU field is set to the first value (e.g., 0), the STA 1 may not immediately transmit a response frame for the PPDU 1 (e.g., PPDU 1 including the final PPDU field set to the first value) to the AP 1.

The preemption field included in the PPDU 1 may be set to a second value (e.g., 1). The preemption field set to the second value (e.g., 1) may indicate that an interval between the PPDU 1 and the next frame is an XIFS and/or that the preemption operation is allowed. The PPDU 1 (e.g., MAC header of an MPDU (A-MPDU) included in the PPDU 1) may include a QoS control field, and the QoS control field may include ACK policy information (e.g., ACK policy field). The ACK policy information of the PPDU 1 (e.g., ACK policy information set to 11) may indicate a block ACK. The ACK policy information of the PPDU 1 indicating the block ACK may indicate that a response frame for the PPDU 1 does not need to be transmitted immediately. The ACK policy information of the PPDU 1 may be included in the MAC header of the MPDU (A-MPDU) included in the PPDU 1.

LL traffic to be transmitted to the STA 2 (e.g., LL STA) may occur in the AP 1. In this case, the AP 1 may transmit an LL PPDU (e.g., DL LL PPDU, LL frame, LL data, LL traffic) to the STA 2 after or within an XIFS from a transmission end time of the PPDU 1. Alternatively, the AP 1 may transmit the LL PPDU to the STA 2 after or within an SIFS from the transmission end time of the PPDU 1. The STA 2 may receive the LL PPDU from the AP 1. The LL PPDU (e.g., MAC header of the LL PPDU) may include preemption information. The final PPDU field included in the preemption information may be set to a first value (e.g., 0). The preemption field included in the preemption information may be set to a first value (e.g., 0) or a second value (e.g., 1). The preemption field set to the first value (e.g., 0) may indicate that an interval between the LL PPDU and the next frame is an SIFS and/or that the preemption operation is not allowed. The preemption field set to the second value (e.g., 1) may indicate that an interval between the LL PPDU and the next frame is an XIFS and/or that the preemption operation is allowed.

Alternatively, the LL PPDU (e.g., MAC header of the LL PPDU) may not include preemption information. The LL PPDU (e.g., MAC header of the LL PPDU) may include a QoS control field, and the QoS control field may include ACK policy information. The ACK policy information (e.g., ACK policy information set to 11) may indicate a block ACK. In this case, the STA 2 may not immediately transmit a response frame (e.g., BA 2) for the LL PPDU to the AP 1.

After an SIFS or XIFS from a transmission end time of the LL PPDU, the AP 1 may transmit a PPDU 2 (e.g., DL PPDU 2, data frame) to the STA 1. Transmission of the PPDU 2 may be delayed by transmission of the LL PPDU. A destination (e.g., recipient) of the PPDU 2 may be the STA 1. The PPDU 2 (e.g., MAC header of an MPDU (A-MPDU) included in the PPDU 2) may include preemption information. The STA 1 may receive the PPDU 2 from the AP 1 and identify the preemption information included in the PPDU 2. The final PPDU field included in the PPDU 2 may be set to a second value (e.g., 1). If the final PPDU field is set to the second value (e.g., 1), the STA 1 may transmit a response frame (e.g., BA 2) for the PPDU 2 (e.g., PPDU 2 including the final PPDU field set to the second value) to the AP 1.

The preemption field included in the PPDU 2 may be set to a first value (e.g., 0). The preemption field set to the first value (e.g., 0) may indicate that an interval between the PPDU 2 and the next frame is an SIFS and/or that the preemption operation is not allowed. The PPDU 2 (e.g., MAC header of an MPDU (A-MPDU) included in the PPDU 2) may include a QoS control field, and the QoS control field may include ACK policy information (e.g., ACK policy field). The ACK policy information of the PPDU 2 (e.g., ACK policy information set to 00) may indicate an implicit BAR. The ACK policy information of the PPDU 1 indicating the implicit BAR may indicate that a response frame for the PPDU 2 needs to be transmitted immediately. The ACK policy information of the PPDU 2 may be included in the MAC header of the MPDU (A-MPDU) included in the PPDU 2.

After an SIFS from a reception end time of the PPDU 2, the STA 1 may transmit a response frame (e.g., BA 2) for the PPDU 1 and the PPDU 2 to the AP 1. The AP 1 may receive the response frame (e.g., BA 1) for the PPDU 1 and the PPDU 2 from the STA 1. Alternatively, the preemption field included in the PPDU 2 may be set to a second value (e.g., 1). In this case, after an XIFS from the reception end time of the PPDU 2, the STA 1 may transmit the response frame (e.g., BA 2) for the PPDU 1 and the PPDU 2 to the AP 1.

The AP 1 may transmit a BAR frame to the STA 2. The BAR frame may be transmitted after a reception end of the response frame (e.g., BA 1) of the STA 1. The BAR frame may request transmission of a response frame (e.g., BA 2) for the LL PPDU of the AP 1. The STA 2 may receive the BAR frame from the AP 1 and may transmit the response frame (e.g., BA 2) for the LL PPDU to the AP 1 in response to the BAR frame. The AP 1 may receive the response frame (e.g., BA 2) for the LL PPDU from the STA 2. The BAR frame of the AP 1 may be transmitted within a TXOP configured by the AP 1. Alternatively, the BAR frame of the AP 1 may be transmitted within a separate TXOP.

In the exemplary embodiments of FIG. 8A and/or FIG. 8B, when transmission of the LL traffic (e.g., transmission of the LL PPDU to the STA 2) by the preemption operation is performed during communication between the AP 1 and the STA 1, the communication between the AP 1 and the STA 1 may be delayed. For example, after transmission of the LL PPDU and/or response frame to the LL PPDU is completed, the communication (e.g., frame transmission) between the STA 1 and the AP 1 may be completed.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of an access point (AP), comprising:
transmitting a first frame to a first station (STA), the first frame including first data and preemption information for a preemption operation;
performing a transmission and reception operation of a low latency (LL) frame with a second STA based on the preemption information; and
receiving a first response frame for the first frame from the first STA.

2. The method of claim 1, wherein the preemption information includes at least one of a preemption field, a final frame field, a random back-off (RBO) contention window (CW) field, or a maximum time field, the preemption field indicates whether the preemption operation is allowed, the final frame field indicates whether the first frame including the final frame field is a final frame, the RBO CW field includes parameter(s) for collision avoidance in the preemption operation, and the maximum time filed indicates a maximum time during which transmission according to the preemption operation is possible.

3. The method of claim 1, wherein an interval between the first frame and a next frame is an LL interframe space (IFS) when the preemption operation is allowed, the interval between the first frame and the next frame is a short interframe space (SIFS) when the preemption operation is not allowed, and the LL IFS is set independently of the SIFS.

4. The method of claim 1, wherein a transmission time or reception time of a second response frame for the LL frame is determined based on acknowledgement (ACK) policy information included in the LL frame, and the ACK policy information indicates a block ACK (BA) or block ACK request (BAR).

5. The method of claim 1, wherein the performing of the transmission and reception operation of the LL frame comprises:
receiving the LL frame from the second STA; and
transmitting a second response frame for the LL frame to the second STA,
wherein the LL frame is received within an LL IFS from a transmission end time of the first frame, and the second response frame is transmitted before reception of the first response frame.

6. The method of claim 5, further comprising: after transmitting the second response frame, transmitting a second frame including second data to the first STA, wherein the first response frame is a response frame for the first frame and the second frame.

7. The method of claim 1, further comprising:
after the LL frame is received from the second STA, receiving, from the second STA, a block ACK request (BAR) frame requesting transmission of a second response frame for the LL frame; and
transmitting the second response frame for the LL frame to the second STA.

8. The method of claim 1, wherein the performing of the transmission and reception operation of the LL frame comprises:
transmitting the LL frame to the second STA; and
receiving a second response frame for the LL frame from the second STA,
wherein the LL frame is transmitted within an LL IFS from a transmission end time of the first frame, and the second response frame is received before reception of the first response frame.

9. The method of claim 8, further comprising: after receiving the second response frame, transmitting a second frame including second data to the first STA, wherein the first response frame is a response frame for the first frame and the second frame.

10. The method of claim 1, further comprising:
in response to the LL frame being transmitted to the second STA, transmitting, to the second STA, a block ACK request (BAR) frame requesting transmission of a second response frame for the LL frame; and
receiving the second response frame for the LL frame from the second STA.

11. A method of a second station (STA), comprising:
obtaining preemption information included in a first frame transmitted by an access point (AP) to a first STA;
determining that a preemption operation is allowed based on the preemption information;
transmitting a low latency (LL) frame to the AP within an LL interframe space (IFS) from a reception end time of the first frame; and
receiving a second response frame for the LL frame from the AP.

12. The method of claim 11, wherein the preemption information includes at least one of a preemption field, a final frame field, a random back-off (RBO) contention window (CW) field, or a maximum time field, the preemption field indicates whether the preemption operation is allowed, the final frame field indicates whether the first frame including the final frame field is a final frame, the RBO CW field includes parameter(s) for collision avoidance in the preemption operation, and the maximum time field indicates a maximum time during which transmission according to the preemption operation is possible.

13. The method of claim 11, wherein an interval between the first frame and a next frame is the LL interframe space (IFS) when the preemption operation is allowed, the interval between the first frame and the next frame is a short interframe space (SIFS) when the preemption operation is not allowed, and the LL IFS is set independently of the SIFS.

14. The method of claim 11, wherein the second response frame is received after an SIFS from a transmission end time of the LL frame, and a transmission operation of the second response frame at the AP is performed before a reception operation of the first response frame for the first frame at the AP.

15. The method of claim 11, further comprising: after transmitting the LL frame, transmitting, to the AP, a block acknowledgment request (BAR) frame requesting transmission of a second response frame for the LL frame,
wherein the second response frame is received in response to the BAR frame.

16. A method of a second station (STA), comprising:
obtaining preemption information included in a first frame transmitted by an access point (AP) to a first STA;
determining that a preemption operation is allowed based on the preemption information;
receiving a low latency (LL) frame from the AP within an LL interframe space (IFS) from a reception end time of the first frame; and
transmitting a second response frame for the LL frame to the AP.

17. The method of claim 16, wherein the preemption information includes at least one of a preemption field, a final frame field, a random back-off (RBO) contention window (CW) field, or a maximum time field, the preemption field indicates whether the preemption operation is allowed, the final frame field indicates whether the first frame including the final frame field is a final frame, the RBO CW field includes parameter(s) for collision avoidance in the preemption operation, and the maximum time field indicates a maximum time during which transmission according to the preemption operation is possible.

18. The method of claim 16, wherein an interval between the first frame and a next frame is an LL interframe space (IFS) when the preemption operation is allowed, the interval between the first frame and the next frame is a short interframe space (SIFS) when the preemption operation is not allowed, and the LL IFS is set independently of the SIFS.

19. The method of claim 16, wherein the second response frame is transmitted after an SIFS from a reception end time of the LL frame, and a transmission operation of the second response frame at the second STA is performed before a reception operation of a first response frame for the first frame at the AP.

20. The method of claim 16, further comprising: after receiving the LL frame, receiving, from the AP, a block acknowledgment request (BAR) frame requesting transmission of the second response frame for the LL frame, wherein the second response frame is transmitted in response to the BAR frame.
